(19) United States
(12) Patent Application Publication
(10) Pub. No.: US 2006/0281531 A1
(43) Pub. Date: Dec. 14, 2006

(54) Gaming machine

(75) Inventor: Mayumi Takeda, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/448,137

(22) Filed: Jun. 7, 2006

(30) Foreign Application Priority Data
Jun. 9, 2005 (JP) P2005-169916

(51) Int. Cl. A63F 13/00

(52) U.S. Cl. 463/20

(57) ABSTRACT

Generation of a second chance game is determined (S41) when symbols in the column of variable display units 21 through 25 are in the prerequisite state in an activated payline. When the player selects any selectable symbol from the symbols in the plurality of prerequisite lines L1 and L2, the selected selectable symbol in the plurality of prerequisite lines L1 and L2 is detected, and the selectable symbol in the selected variable display unit 23 (‘two-BAR’ symbol in L1) is variably displayed again and then stopped and displayed, and a payout made if a win has occurred.

### CROSS REFERENCE TO RELATED APPLICATIONS

This application is based upon and claims the benefit of priority from the Japanese Patent Application No. 2005-169916 filed on Jun. 9, 2005 in the Japanese Patent Office; the entire contents of which are incorporated herein by reference.

### BACKGROUND OF THE INVENTION

1. Field of the Invention

The present invention relates to a gaming machine for playing games using symbols variably displayed and stopped and displayed.

2. Description of the Related Art

In previous gaming machines, for example, in slot machines, a plurality of reels are rotated for a prescribed time, and coin paid out in response to the combination of symbols in the state wherein the reels are stopped (for example, Unexamined Patent Publication No. 2003-180908). Furthermore, a slot machine wherein the player is led to expect that a specific winning combination is readily arrayed under the condition that the player moves to a bonus game has been proposed (for example, Unexamined Patent Publication No. 2005-34301).

However, in base games, since the game is completed if the player does no twin after the variably displayed symbols are stopped and displayed, the machine could not start a bonus game despite a result of a just before game, even if a plurality of activated paylines are in the prerequisite state. Therefore, the player loses the sense of expectation when the base game is completed. Furthermore, variable display of the symbols is commenced by operation of the bet button or the start lever and the like, however each variable display is stopped automatically. That is to say, the player simply watches the varying and stopped symbols in each variable display unit, and the machine could not receive an instruction from the player between the instant when variable display of the symbols commenced and the instant when the result of the slot game fixed. Therefore, the player has a very minimal impression of having personally contributed to the result of the slot game.

### SUMMARY OF THE INVENTION

The embodiment of the present invention provides further opportunity for lottery after it has been determined that the player has not won with display and stopping of the symbols, and the player is made to actively contribute to the game by selecting symbols, thus raising the level of interest in the game.

The first feature provided in the present invention is a gaming machine (for example, slot machine 1) including a plurality of columns of variable display units (for example, variable display units 21 through 25), wherein symbols in the variable display unit in each column are drawn and a payout is made when the symbols are stopped in a prescribed combination in the activated payline, having providing means (for example, CPU50, S41) for providing opportunity for re-lottery of some of the symbols in the variable display unit being symbols to be selected in the prerequisite line when a plurality of activated paylines are in the prerequisite state, that is a plurality of prerequisite lines have been generated, as a result of lottery detection means (for example, CPU 50, touch-panel 121, S81) for detecting some of the symbols in the variable display units selected in accordance with instructions of the player, and display control means (for example, CPU 50, S83, S85) for stopping and displaying based on results of lottery after some of the symbols in the variable display units detected with the detection means have been variably displayed again. By configuration in this manner, even when a base game is completed without a win, opportunity for re-lottery of some of the symbols in the variable display units not arrayed in the prerequisite line can be provided, and thus the expectations of the player are raised, giving rise to a desire to continue the game. However, since the player is made to select symbols from a plurality of prerequisite lines, the player actively contributes to the game, raising the level of interest in the game.

The second feature provided in the present invention is a gaming machine (for example, slot machine 1) having the first feature, wherein the means for providing opportunity for re-sampling some of the variable display units (for example, CPU50, S41) determines by sampling (for example, S60) whether or not to provide opportunity for re-lottery of some of the variable display units when a plurality of prerequisite lines (for example, L1, L2) is generated for a plurality of activated paylines. Thus, opportunity for re-lottery of some of the variable display units not arrayed in the prerequisite lines can be generated in the form of a mystery bonus.

The third feature provided in the present invention is a gaming machine (for example, slot machine 1) having the first feature, wherein the providing means (for example, CPU50, S41) provides opportunity for re-lottery of some of the variable display units (for example, S70), provided a plurality of prerequisite lines includes a prerequisite line comprised of a specific predetermined symbol (for example, ‘SEVEN’). Thus, the player can be aware of generation of opportunity for re-lottery of some variable display units from symbols in the generated prerequisite lines.

The fourth feature provided in the present invention is a gaming machine (for example, slot machine 1) having any of the first through third features, wherein the display control means (for example, CPU50, S83, S85) displays the relevant symbol in a special manner (for example, S86) so that the winning symbol of the symbols included in the prerequisite line is apparent when the player has not won despite re-lottery with the opportunity provided with the providing means. Thus, the player can be informed of the winning symbol when the player has not won despite re-lottery.

In the following description, ‘opportunity for re-lottery of some of the symbols in the variable display units’ is referred to as ‘second chance’.

### BRIEF DESCRIPTION OF THE DRAWINGS

FIG. 1A is a display example of a variable display unit wherein a plurality of prerequisite lines (L1, L2) has been established. FIG. 1B is a display example of a variable display unit after the ‘two-BAR’ symbol in the prerequisite line L1 has been selected and variably displayed again. FIG. 1C is a display example of a variable display unit after the ‘three-BAR’ symbol in the prerequisite line L2 has been selected and variably displayed again;

FIG. 2A is a display example of a variable display unit wherein a plurality of prerequisite lines (L3, L4) has been established. FIG. 2B is a display example of a variable display unit after the ‘CHERRY’ symbol in the prerequisite line L4 has been selected and variably displayed again. FIG. 2C is a display example of a variable display unit after the ‘SEVEN’ symbol in the prerequisite line L3 has been selected and variably displayed again;

FIG. 3 is the main processing program flowchart;

FIG. 4 is the start receive processing flowchart;

FIG. 5 is the lottery processing flowchart;

FIG. 6 is the bonus game processing flowchart;

FIG. 7 is the sample processing flowchart for the second chance game with lottery;

FIG. 8 is the evaluation processing flowchart for the second chance game with a specific symbol;

FIG. 9 is the second chance game processing flowchart;

FIG. 10 is a perspective view of the slot machine;

FIG. 11 is a front view of the operating table or touch-panel;

FIG. 12 is a block diagram showing the slot machine control system in schematic format;

FIG. 13 is a block diagram showing the liquid crystal display driving circuit in schematic format;

FIG. 14 shows the stop and display regions of the five variable display units;

FIG. 15 is an explanatory diagram showing an example of the configuration of four of the twenty-five activated paylines;

FIG. 16 is an explanatory diagram showing an example of the variably displayed symbols in the variable display units in a base game in schematic format;

FIG. 17 is an explanatory diagram showing a stopped and displayed symbol lottery table;

FIG. 18 is an explanatory diagram showing a winning combination and payout;

FIG. 19 is an explanatory diagram showing a stopped and displayed symbol lottery table;

FIG. 20 is an explanatory diagram showing a second chance game lottery table; and

FIG. 21 is an explanatory diagram showing a lottery table for lottery of each winning line in a second chance game.

### DESCRIPTION OF THE PREFERRED EMBODIMENTS

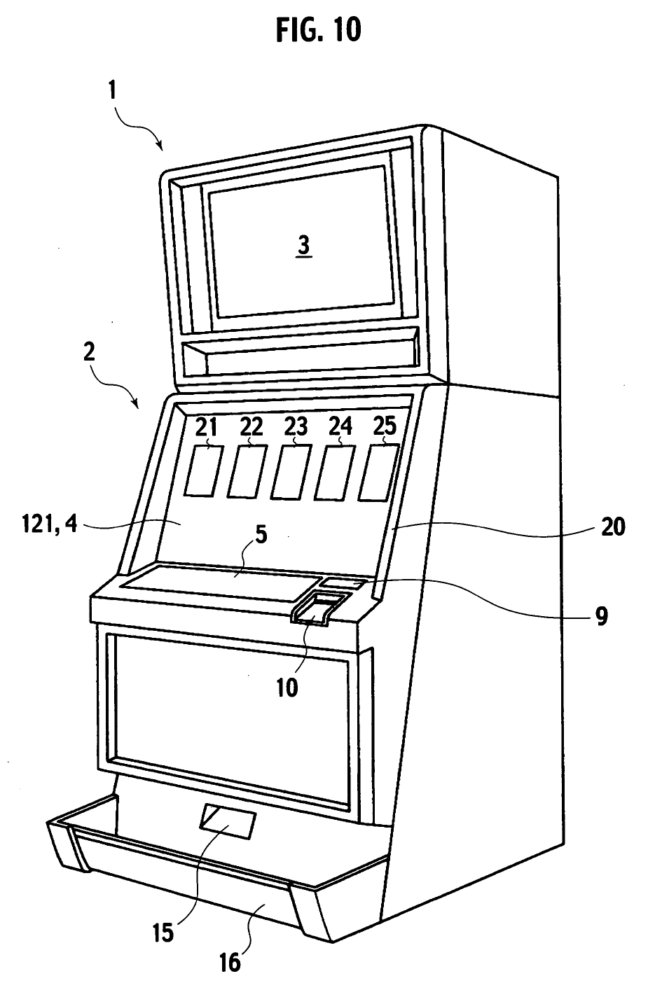

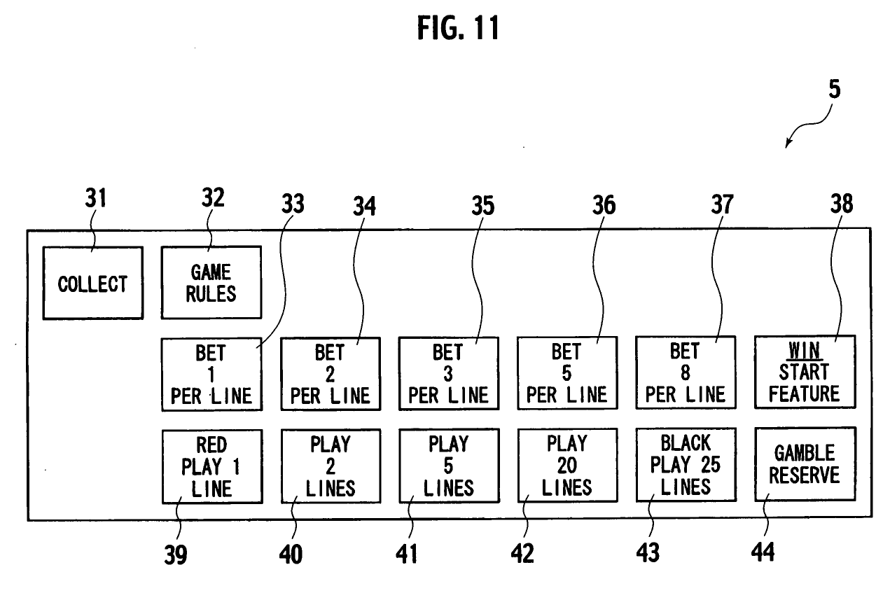

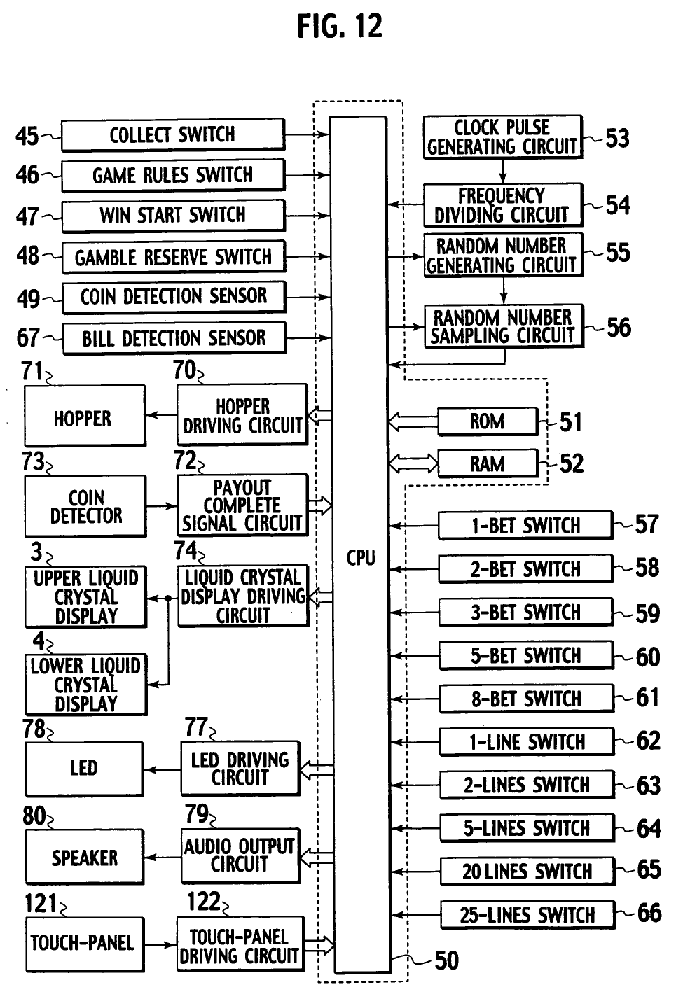

The embodiments of the present invention as applied to a slot machine are described later in detail in reference to the drawings. Firstly, the outline of the configuration of the slot machine according to the present embodiment is described in FIG. 10 through 12. FIG. 10 is a perspective view of the slot machine. FIG. 11 is a front view of the operating panel. FIG. 12 is a block diagram showing the control system of the slot machine in schematic format.

In FIG. 10, the slot machine 1 has a cabinet 2 forming the body, an upper liquid crystal display 3 provided at the top of the front face of the cabinet 2, and a lower liquid crystal display 4 provided in the machine front panel 20 in the center of the front face of the cabinet 2. The upper liquid crystal display 3 and the lower liquid crystal display 4 are comprised of general-purpose liquid crystal displays. Information related to the game such as game method, winning combinations and payouts for same, and various effects and the like related to the game are displayed on the upper liquid crystal display 3. A touch-panel 121 is provided on the screen of the lower liquid crystal display 4. Credit is displayed, and as shown in FIG. 10, five variable display units 21, 22, 23, 24, and 25 are displayed basically, on the lower liquid crystal display 4. The various symbols described later are variably displayed while scrolled from top to bottom (hereafter referred to as ‘scroll display’) in each variable display unit 21 through 25, and then stopped and displayed.

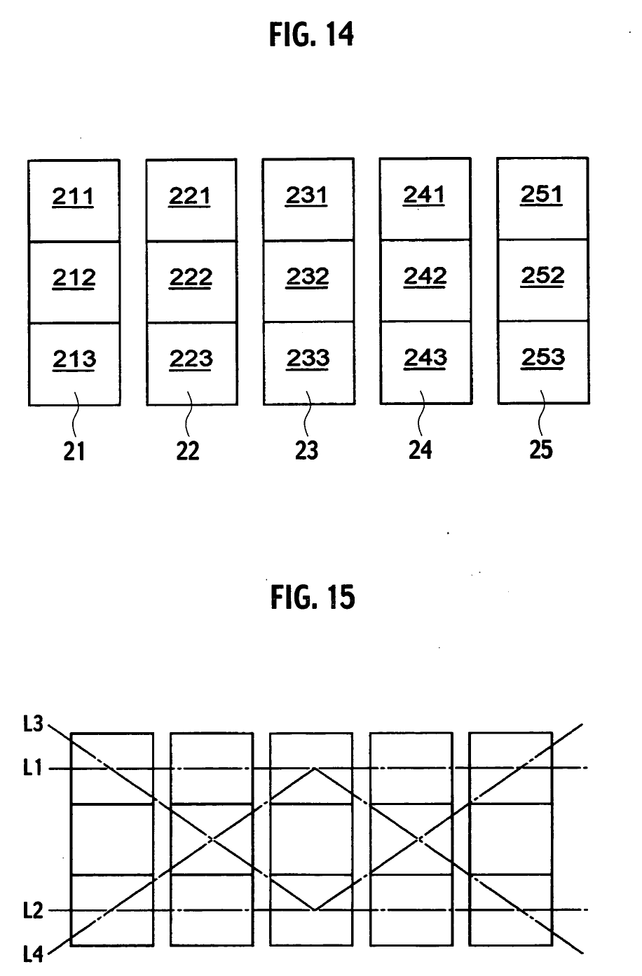

In the slot machine 1 of the first embodiment, slot games (base games and bonus games) are played with video reels displayed on the variable display units 21 through 25 of the lower liquid crystal display 4. Three symbols are stopped and displayed on each of the variable display units 21 through 25. As shown in FIG. 14, the variable display units 21 through 25 are differentiated into the primary stop and display regions 211, 221, 231, 241, and 251, the secondary stop and display regions 212, 222, 232, 242, and 252, and the tertiary stop and display regions 213, 223, 233, 243, and 253. Symbols are stopped and displayed in each of the stop and display regions 211 through 213, 221 through 223, 231 through 233, 241 through 243, and 251 through 253.

This slot game has twenty-five paylines formed of five stop and display regions among fifteen stop and display regions 211 through 213, 221 through 223, 231 through 233, 241 through 243, and 251 through 253. Payout occurs if a specific symbol is queued in a specific mode in an activated payline. For convenience in description, four of the twenty-five paylines are described using FIG. 15.

As shown in FIG. 15, the first payline L1 is formed in the primary stop and display regions 211, 221, 231, 241, and 251. The second payline L2 is formed in the tertiary stop and display regions 213, 223, 233, 243, and 253. The third payline L3 is formed in the stop and display regions 211, 222, 233, 242, and 251. The fourth payline L4 is formed in the stop and display regions 213, 222, 231, 242, and 253.

Those of the twenty-five paylines activated are referred to as ‘activated paylines’.

As shown in FIG. 10, the operating table 5 projecting towards the player is provided at the bottom of the lower liquid crystal display 4. As shown in FIG. 11, the COLLECT button 31 and the GAME RULES button 32 are provided from left in the upper stage of the operating table 5, the BET 1 PER LINE button 33, BET 2 PER LINE button 34, BET 3 PER LINE button 35, BET 5 PER LINE button 36, BET 8 PER LINE button 37, and WIN START FEATURE button 38 are provided from left in the middle stage of the operating table 5, and the RED PLAY 1 LINE button 39, PLAY 2 LINES button 40, PLAY 5 LINES button 41, PLAY 20 LINES button 42, BLACK PLAY 25 LINES button 43, and GAMBLE RESERVE button 44 are provided from left in the lower stage of the operating table 5. Furthermore, as shown in FIG. 10, the coin insertion slot 9, and the bill insertion slot 10, are provided at the right of the operating table 5.

The COLLECT button 31 is pressed when the base game is completed. When the COLLECT button 31 is pressed, the equivalent value in coin of the number of credits acquired in the game is refunded from the coin payout slot 15 to the coin receiver 16. A COLLECT switch 45 is fitted to the COLLECT button 31, and when the COLLECT button 31 is pressed, a switch signal is output to the CPU 50 (see FIG. 12).

The GAME RULES button 32 is pressed if the game operating procedure and the like are unclear. When the GAME RULES button 32 is pressed, various help information is displayed on the upper liquid crystal display 3 and the lower liquid crystal display 4. A GAME RULES switch 46 is fitted to the GAME RULES button 32, and when the GAME RULES button 32 is pressed, a switch signal is output from the GAME RULES switch 46 to the CPU 50 (see FIG. 12).

A coin detection sensor 49 is provided in a coin insertion slot 9. When a coin is inserted in the coin insertion slot 9, a coin detect signal is output from the coin detection sensor 49 to the CPU 50 (see FIG. 12), and a credit equivalent to the inserted coin is added. Furthermore, a bill detection sensor 67 is provided in the bill insertion slot 10. When a bill is inserted in the bill insertion slot 10, the bill detect signal is output from the bill detection sensor 67 to the CPU 50 (see FIG. 12), and a credit equivalent to the inserted bill is added.

Each time the BET 1 PER LINE button 33 is pressed, a single bet is made for each activated payline. A 1-BET switch 57 is fitted to the BET 1 PER LINE button 33. When the BET 1 PER LINE button 33 is pressed, a switch signal is output from the 1-BET switch 57 to the CPU 50 (see FIG. 12).

Each time the BET 2 PER LINE button 34 is pressed, two bets are made for each activated payline. A 2-BET switch 58 is fitted to the BET 2 PER LINE button 34. When the BET 2 PER LINE button 34 is pressed, a switch signal is output from the 2-BET switch 58 to the CPU 50 (see FIG. 12).

Each time the BET 3 PER LINE button 35 is pressed, three bets are made for each activated payline. A 3-BET switch 59 is fitted to the BET 3 PER LINE button 35. When the BET 3 PER LINE button 35 is pressed, a switch signal is output from the 3-BET switch 59 to the CPU 50 (see FIG. 12).

Each time the BET 5 PER LINE button 36 is pressed, five bets are made for each activated payline. A 5-BET switch 60 is fitted to the BET 5 PER LINE button 36. When the BET 5 PER LINE button 36 is pressed, a switch signal is output from the 5-BET switch 60 to the CPU 50 (see FIG. 12).

Each time the BET 8 PER LINE button 37 is pressed, eight bets are made for each activated payline. A 8-ET switch 61 is fitted to the BET 8 PER LINE button 37. When the BET 8 PER LINE button 37 is pressed, a switch signal is output from the 8-BET switch 61 to the CPU 50 (see FIG. 12).

The number of bets possible by pressing the BET 1 PER LINE button 33, BET 2 PER LINE button 34, BET 3 PER LINE button 35, BET 5 PER LINE button 36, and BET 8 PER LINE button 37 is therefore 1, 2, 3, 5, or 8.

The WIN START FEATURE button 38 is for commencing a bonus game, and adding a payout acquired in a bonus game to the credit A WIN START switch 47 is fitted to the W IN START FEATURE button 38. When the WIN START FEATURE button 38 is pressed, a switch signal is output from the WIN START switch 47 to the CPU 50 (see FIG. 12).

When the RED PLAY 1 LINE button 39 is pressed, a game is commenced with the number of activated paylines as ‘1’. A 1-LINE switch 62 is fitted to the RED PLAY 1 LINE button 39. When the RED PLAY 1 LINE button 39 is pressed, a switch signal is output from the 1-LINE switch 62 to the CPU 50 (see FIG. 12).

When the PLAY 2 LINES button 40 is pressed, a game is commenced with the number of activated paylines as ‘2’. A 2-LINES switch 63 is fitted to the PLAY 2 LINES button 40. When the PLAY 2 LINES button 40 is pressed, a switch signal is output from the 2-LINES switch 63 to the CPU 50 (see FIG. 12).

When the PLAY 5 LINES button 41 is pressed, a game is commenced with the number of activated paylines as ‘5’. A 5-LINES switch 64 is fitted to the PLAY 5 LINES button 41. When the PLAY 5 LINES button 41 is pressed, a switch signal is output from the 5-LINES switch 64 to the CPU 50 (see FIG. 12).

When the PLAY 20 LINES button 42 is pressed, a game is commenced with the number of activated paylines as ‘20’. A 20-LINES switch 65 is fitted to the PLAY 20 LINES button 42. When the PLAY 20 LINES button 42 is pressed, a switch signal is output from the 20-LINES switch 65 to the CPU 50 (see FIG. 12).

When the BLACK PLAY 25 LINES button 43 is pressed, a game is commenced with the number of activated paylines as ‘25’. A 25-LINES switch 66 is fitted to the BLACK PLAY 25 LINES button 43. When the BALCK PLAY 25 LINES button 43 is pressed, a switch signal is output from the 25-LINES switch 66 to the CPU 50 (see FIG. 12).

When the RED PLAY 1 LINE button 39 is pressed, the payline L1 shown in FIG. 15 is activated. When the PLAY 2 LINES button 40 is pressed, the paylines L1 and L2 shown in FIG. 15 are activated. When the PLAY 5 LINES button 41 is pressed, the four paylines L1 through L4 shown in FIG. 15, and one payline not shown in the figure (total of five paylines), are activated. When the PLAY 20 LINES button 42 is pressed, the four paylines L1 through L4 shown in FIG. 15, and sixteen paylines not shown in the figure (total of twenty paylines), are activated. When the BLACK PLAY 25 LINES button 43 is pressed, the four paylines L1 through L4 shown in FIG. 15, and twenty-one paylines not shown in the figure (total of twenty-five paylines), are activated.

The number of activated paylines which can be determined by pressing the RED PLAY 1 LINE button 39, PLAY 2 LINES button 40, PLAY 5 LINES button 41, PLAY 20 LINES button 42, or BLACK PLAY 25 LINES button 43 can therefore be set as ‘1’, ‘2’, ‘5’, ‘20’, or ‘25’.

Furthermore, when the RED PLAY 1 LINE button 39, PLAY 2 LINES button 40, PLAY 5 LINES button 41, PLAY 20 LINES button 42, or BLACK PLAY 25 LINES button 43 is pressed, a game is commenced with the number of bets at the time the button was pressed, and the number of activated paylines corresponding to the pressed button, and variable display of the symbols is commenced on the variable display units 21 through 25 on the lower liquid crystal display 4.

The RED PLAY 1 LINE button 39 and the BLACK PLAY 2 LINES button 43 are also used to select red or black in double-own games played using credits acquired in bonus games.

The GAMBLE RESERVE button 44 is for pressing when leaving the seat, or when moving to a double-down game after completing a bonus game. A GAMBLE RESERVE switch 48 is fitted to the GAMBLE RESERVE button 44. When the GAMBLE RESERVE button 44 is pressed, a switch signal is output from the GAMBLE RESERVE switch 48 to the CPU 50 (see FIG. 12).

The coin payout slot 15 is formed, and the coin receiver 16 receiving coin paid out from the coin payout slot 15 is provided, in the bottom of the cabinet 2. A coin detector 73 (described later) comprised of a sensor and the like is provided in the coin payout slot 15. The coin detector 73 detects the number of coins paid out from the coin payout slot 15.

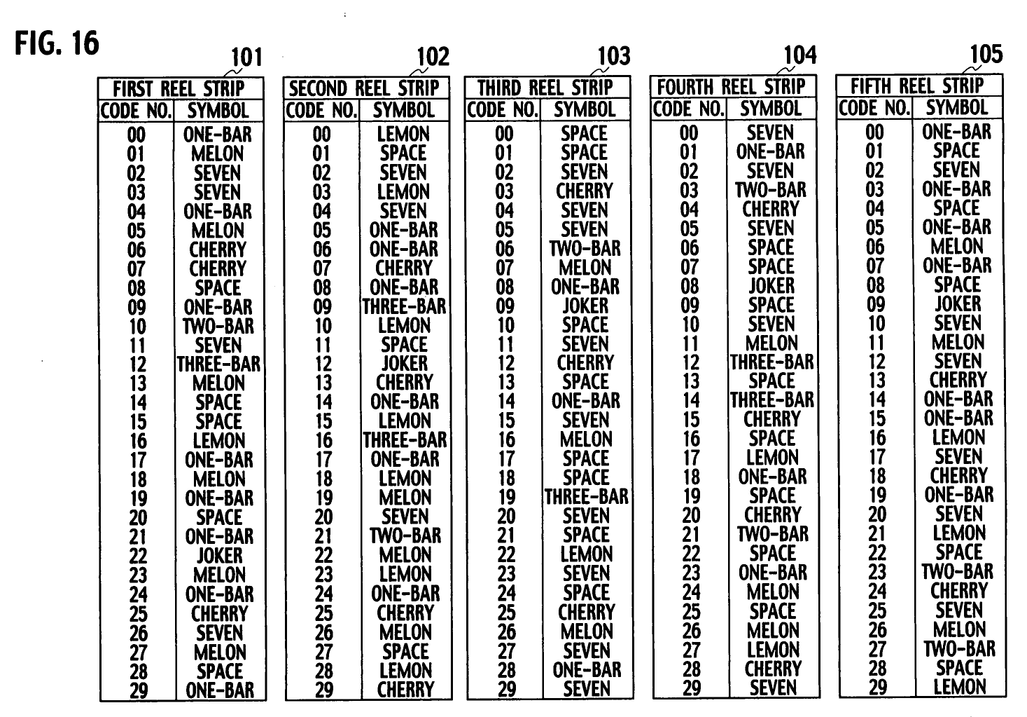

Examples of symbols variably displayed while scrolling on the variable display units 21 through 25 of the lower liquid crystal display 4 when playing base games are described based on FIG. 16. The column of symbols shown in the first reel strip 101 is the column of symbols variably displayed on the variable display unit 21, the column of symbols shown in the second reel strip 102 is the column of symbols variably displayed on the variable display unit 22, the column of symbols shown in the third reel strip 103 is the column of symbols variably displayed on the variable display unit 23, the column of symbols shown in the fourth reel strip 104 is the column of symbols variably displayed on the variable display unit 24, and the column of symbols shown in the fifth reel strip 105 is the column of symbols variably displayed on the variable display unit 25.

Here, the columns of symbols shown in the reel strips 101 through 105 have arrays of mutually differing symbols, and these columns of symbols are comprised of the twelve symbols ‘SEVEN’, ‘three-BAR’, ‘one-BAR’, ‘two-BAR’, ‘LEMON’, ‘MELON’, ‘CHERRY’, ‘SPACE’, and ‘JOKER’ combined appropriately.

As described later, ‘JOKER’ is also a scatter symbol for moving to bonus games. The player can move to a bonus game when three or more ‘JOKER’ symbols are stopped and displayed on the variable display units 21 through 25, irrespective of activated paylines.

When the columns of symbols shown in the reel strips 101 through 105 are stopped and displayed following scroll display on the variable display units 21 through 25, each of three symbols is stopped and displayed on each variable display unit as described above.

Each winning combination is preset according to the combination of symbols. When the combination of symbols corresponding to the winning combination is stopped on an activated payline, operation is the same as for the conventional slot machine in terms of payout for the winning combination being added to the credit, and a description is therefore omitted here.

Next, the configuration of the control system of the slot machine 1 is described based on FIG. 12. FIG. 12 is a block diagram showing the slot machine control system in schematic format

In FIG. 12, the control system of the slot machine 1 is fundamentally comprised of a central CPU 50, and a ROM 51 and RAM 52 connected to the CPU 50. A main processing program, a base game processing program, a bonus game processing program, a lottery table for lottery of stopped and displayed symbols in the base game, a lottery table for lottery of stopped and displayed symbols in the bonus game, a lottery table for second chance lottery, a lottery table for lottery on each payline in second chance games, and various programs and data tables and the like necessary for control of the slot machine 1, and described later, are stored in the ROM 51. Furthermore, the RAM 52 is a memory temporarily storing various types of data computed by the CPU 50.

A clock pulse generating circuit 53 generating a reference clock pulse, a frequency dividing circuit 54, a random number generating circuit 55 generating random numbers, and a random number sampling circuit 56, are connected to the CPU 50. Random numbers sampled with the random number sampling circuit 56 are used in various lottery of winning combinations and the like. Furthermore, the COLLECT switch 45 fitted to the COLLECT button 31, the GAME RULES switch 46 fitted to the GAME RULES button 32, the 1-BET switch 57 fitted to the BET 1 PER LINE button 33, the 2-BET switch 58 fitted to the BET 2 PER LINE button 34, the 3-BET switch 59 fitted to the BET 3 PER LINE button 35, the 5-BET switch 60 fitted to the BET 5 PER LINE button 36, the 8-BET switch 61 fitted to the BET 8 PER LINE button 37, the WIN START switch 47 fitted to the WIN START FEATURE button 38, the 1-LINE switch 62 fitted to the RED PLAY 1 LINE button 39, the 2-LINES switch 63 fitted to the PLAY 2 LINES button 40, the 5-LINES switch 64 fitted to the PLAY 5 LINES button 41, the 20-LINES switch 65 fitted to the PLAY 20 LINES button 42, the 25-LINES switch 66 fitted to the BLACK PLAY 25 LINES button 43, and the GAMBLE RESERVE switch 48 fitted to the GAMBLE RESERVE button 44, are each connected to the CPU 50. The CPU 50 conducts various controls to execute operation corresponding to buttons based on signals output from each switch when each button is pressed.

Furthermore, the coin detection sensor 49 provided in the coin insertion slot 9, and the bill detection sensor 67 provided in the bill insertion slot 10, are connected to the CPU 50. The coin detection sensor 49 detects coins inserted from the coin insertion slot 9, and the CPU 50 computes the number of coins inserted based on the coin detect signals output from the coin detection sensor 49. The bill detection sensor 67 detects the type and value of bills inserted from the bill insertion slot 10, and the CPU 50 computes the value of the bills, and an equivalent credit, based on the bill detect signals output from the bill detection sensor 67.

A hopper 71 is connected to the CPU 50 via a hopper driving circuit 70. When the driving signal is output to the hopper driving circuit 70 from the CPU 50, the hopper 71 pays out the predetermined number of coins to the coin payout slot 15.

Furthermore, the coin detector 73 is connected to the CPU 50 via a payout complete signal circuit 72. The coin detector 73 is provided in the coin payout slot 15. When the predetermined number of coins is detected to have been paid out from the coin payout slot 15, the coin payout detect signal is output from the coin detector 73 to the payout complete signal circuit 72. The payout complete signal circuit 72 outputs the payout complete signal to the CPU 50 when the coin payout detect signal is received. Furthermore, the upper liquid crystal display 3 and the lower liquid crystal display 4 are connected to the CPU 50 via a liquid crystal display driving circuit 74, and the CPU 50 controls the upper liquid crystal display 3 and the lower liquid crystal display 4.

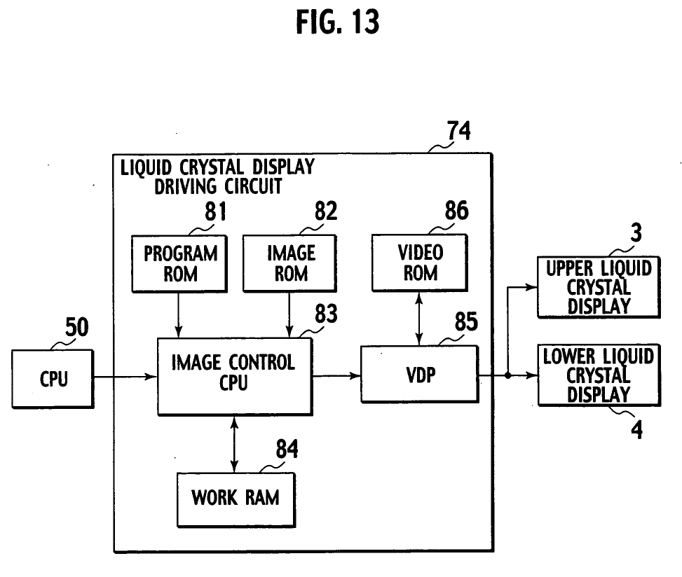

As shown in FIG. 13, the liquid crystal display driving circuit 74 is comprised of a program ROM 81, an image ROM 82, an image control CPU 83, a work RAM 84, a video display processor (VDP) 85, and a video RAM 86 and the like. The image control program, and various selection tables related to display on the upper liquid crystal display 3 and the lower liquid crystal display 4 are stored in the program ROM 81. Dot data for forming images, for example, the columns of symbols displayed in reel strips 101 through 105 in FIG. 16 and displayed on the lower liquid crystal display 4 (or the variable display units 21 through 25), are stored in the image ROM 82. The image control CPU 83 determines the images displayed on the upper liquid crystal display 3 and the lower liquid crystal display 4 from the dot data previously stored in the image ROM 82 in accordance with the image control program previously stored in the program ROM 81 based on the parameters set by the CPU 50. The work RAM 84 is temporary storage means when the image control CPU 83 executes the image control program. The VDP 85 forms an image according to the display content determined by the image control CPU 83, and outputs this image to the upper liquid crystal display 3 and the lower liquid crystal display 4. Thus, for example, the columns of symbols and the like shown in the reel strips 101 through 105 are scroll-displayed on the lower liquid crystal display 4 (or the variable display units 21 through 25). The video RAM 86 is temporary storage means when the image is formed with the VDP 85.

Furthermore, a plurality of LEDs 78 are connected to the CPU 50 via an LED driving circuit 77. The LEDs 78 are provided on the front face of the slot machine 1 to provide various effects. Lighting is controlled with the LED driving circuit 77 based on the driving signal from the CPU 50. Furthermore, the speaker 80 is connected to the CPU 50 via an audio output circuit 79. The speaker 80 is connected to the audio output circuit 79. The speaker 80 generates various sound effects when providing various effects based on the output signal from the audio output circuit 79.

Furthermore, the touch-panel 121 is connected to the CPU 50 via the touch-panel driving circuit 122. The touch-panel 121 is provided on the screen of the lower liquid crystal display 4, and when the variable display units 21 through 25 are touched, this touch is recognized, and whether the screen has been touched in the primary stop and display regions 211, 221, 231, 241, and 251, the secondary stop and display regions 212, 222, 232, 242, and 252, or the tertiary stop and display regions 213, 223, 233, 243, and 253, can be recognized, via the touch-panel driving circuit 122.

That is to say, the touch-panel 121 can discriminate, via the touch-panel driving circuit 122, which of the variable display units 21 through 25 has been touched based on coordinate information for the part touched by the player.

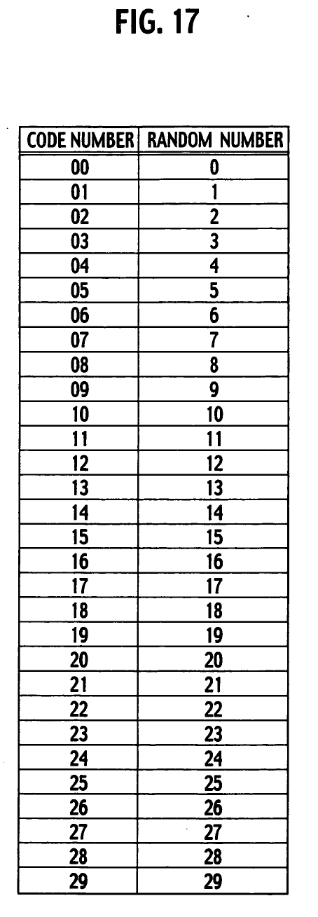

The lottery table used when determining the symbols stopped and displayed in the activated payline in base games played using the five variable display units 21 through 25 of the slot machine 1 is described based on FIG. 17. FIG. 17 shows the lottery table of stopped and displayed symbols when a game is played using the five variable display units 21 through 25.

For example, the code numbers ‘00’ through ‘29’ are allocated to each symbol on the reel strips 101 through 105 as shown in FIG. 16. On the other hand, the lottery table shown in FIG. 17 is provided. The five random numbers corresponding to the variable display units 21 through 25 are sampled via the sampling circuit 56.

If it is assumed that the sampled random number for the reel strip 101 is ‘0’, the ‘one-BAR’ symbol allocated to the code number ‘00’ is stopped and displayed in the activated payline. The code number corresponding to the random number is also determined based on the lottery table shown in FIG. 17 when the random number is between ‘1’ and ‘29’, and the symbol corresponding to the code number is determined based on each reel strip. The determined symbols are stopped and displayed in the activated payline.

This control is conducted similarly for the second reel strip 102 scroll-displayed in the variable display unit 22, the third reel strip 103 scroll-displayed in the variable display unit 23, the fourth reel strip 104 scroll-displayed in the variable display unit 24, and the fifth reel strip 105 scroll-displayed in the variable display unit 25.

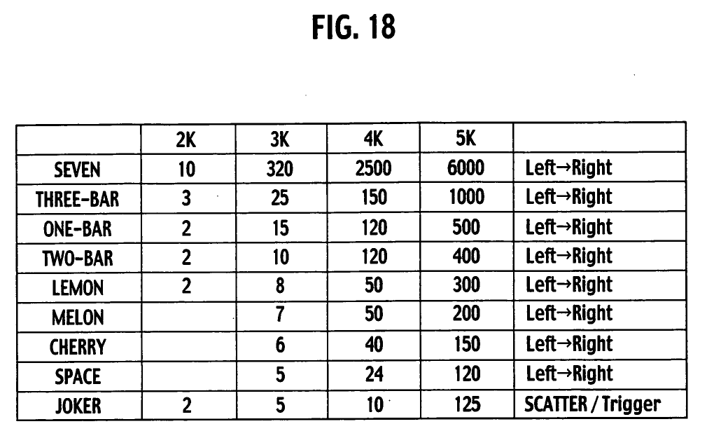

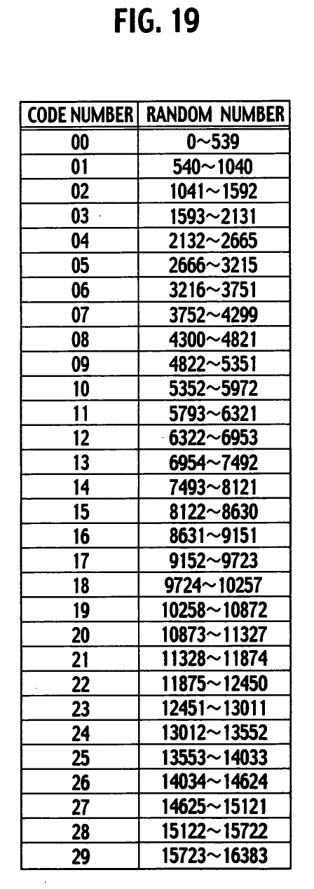

Next, the winning combination and payout for same when playing a base game using the five variable display units 21 through 25 in the slot machine 1 are described based on FIG. 18. FIG. 18 is a descriptive diagram showing the winning combination and payout for same when playing a base game using the five variable display units, and shows the payout when the number of bets is ‘1’. When the number of bets is ‘1’, the value of the payout shown in FIG. 18 is added to the credit When the number of bets is ‘2’ or greater, the value of the payout shown in FIG. 18 multiplied by the relevant number of bets is added to the credit.

The winning combination and payout for same when a base game is played is described in practical detail. As shown in FIG. 18, when the ‘SEVEN’ symbol is stopped and displayed consecutively in the activated payline in variable display units 21 and 22 (‘2K’ means that two same symbols are displayed consecutively from the left edge), a payout of ‘10’ is obtained. Furthermore, when this symbol is stopped and displayed consecutively in the activated payline in variable display units 21 through 23 (‘3K’ means that three same symbols are displayed consecutively from the left edge), a payout of ‘320’ is obtained. Furthermore, when this symbol is stopped and displayed consecutively in the activated payline in variable display units 21 through 24 (‘4K’ means that four same symbols are displayed consecutively from the left edge), a payout of ‘2500’ is obtained. Furthermore, when this symbol is stopped and displayed consecutively in the activated payline in variable display units 21 through 25 (‘5K’ means that five same symbols are displayed consecutively from the left edge), a payout of ‘6000’ is obtained. With other symbols as well, when the stopped and displayed symbols are ‘2K’, ‘3K’, ‘4K’, or ‘5K’, the payouts shown in FIG. 18 are obtained.

When the symbols for payout are stopped and displayed in a plurality of activated paylines, the total value of all payouts is added to the credit.

On the other hand, with the ‘JOKER’ symbol, a payout of ‘2’ is obtained when ‘JOKER’ appears twice (stopped and displayed), a payout of ‘5’ is obtained when ‘JOKER’ appears three times (stopped and displayed), a payout of ‘10’ is obtained when ‘JOKER’ appears four times (stopped and displayed), and a payout of ‘125’ is obtained when ‘JOKER’ appears five times (stopped and displayed), irrespective of the activated payline on the variable display units 21 through 25.

The payout value shown in FIG. 18 is multiplied by the total number of bets (the product of the number of bets and the number of activated paylines), and added to the credit, only for payouts with the ‘JOKER’ symbol. When payouts are also made with other than the ‘JOKER’ symbol, the payout is also added to the credit.

Furthermore, the payout is obtained, and the player can move to a bonus game, when the ‘JOKER’ symbol appears three or more times (stopped and displayed), irrespective of the activated paylines on the variable display units 21 through 25.

A bonus game is a game played after a base game, and is frequently advantageous to the player. Here, when the player moves to a bonus game, between 15 and 25 consecutive games are played automatically, without betting the credit and the like, according to the results of lottery at the time of moving to the bonus game.

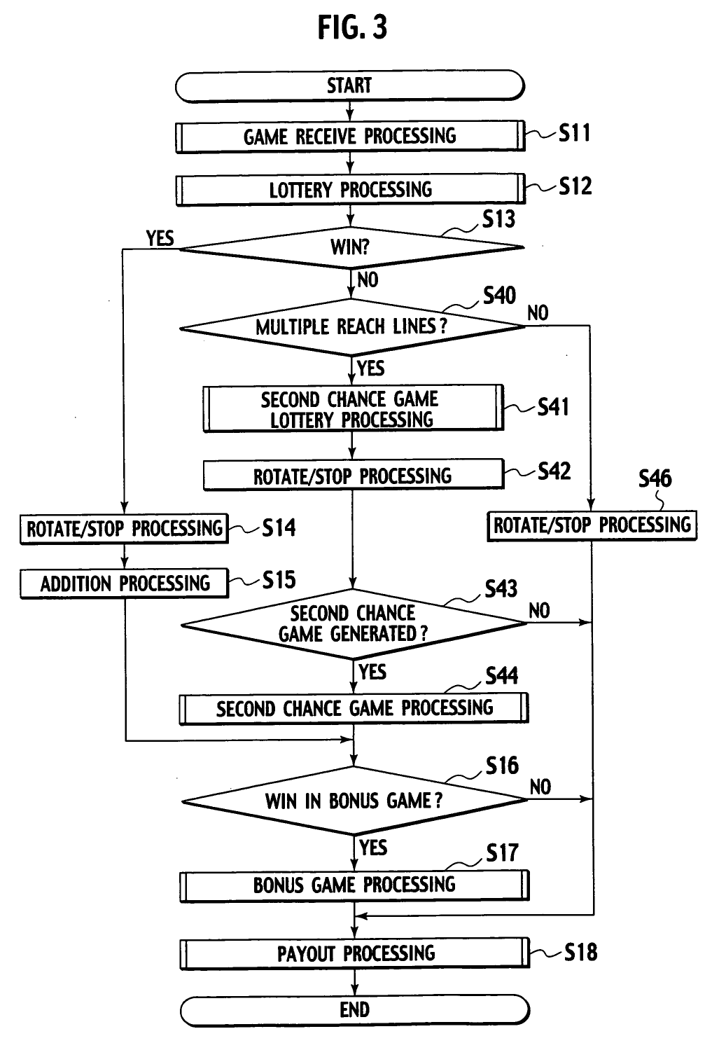

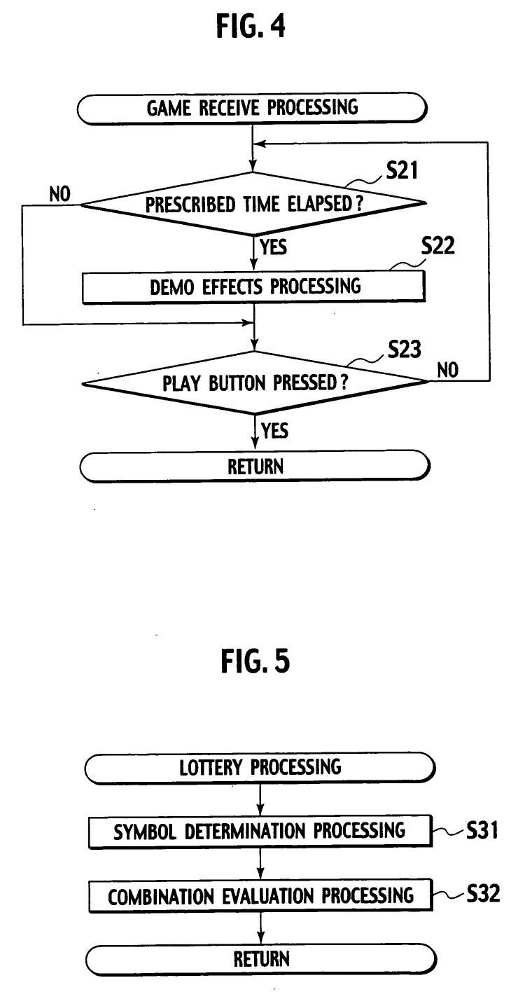

Next, the main processing program executed on the slot machine 1 is described based on FIG. 3. In FIG. 3 the start receive processing described later in FIG. 4 is conducted first in step (hereafter abbreviated by ‘S’) 11. This processing receives switch signals output from the 1-BET switch 57, the 2-BET switch 58, the 3-BET switch 59, the 5-BET switch 60, the 8-BET switch 61, the 1-LINE switch 62, the 2-LINES switch 63, the 5-LINES switch 64, the 20-LINES switch 65, and the 25-LINES switch 66 based on operation of the BET 1 PER LINE button 33, the BET 2 PER LINE button 34, the BET 3 PER LINE button 35, the BET 5 PER LINE button 36, the BET 8 PER LINE button 37, the RED PLAY 1 LINE button 39, the PLAY 2 LINES button 40, the PLAY 5 LINES button 41, the PLAY 20 LINES button 42, or the BLACK PLAY 25 LINES button 43. A game is commenced when a switch signal output from each switch is received.

The game receive processing program executed on the slot machine 1 is described based on FIG. 4. FIG. 4 is the game receive processing flowchart Game receive processing is executed in S11 of the main processing program in FIG. 3. In game receive processing, the first step (step S21 in FIG. 4) evaluates whether or not the prescribed time (for example, 15 seconds) has elapsed.

If the predetermined time has not elapsed (NO in S21), processing proceeds to S23 without further action. If the predetermined time has elapsed (YES in S21), the demo effects are then displayed on the upper liquid crystal display 3 and the lower liquid crystal display 4 in S22, and processing proceeds to S23. In S23, an evaluation is made to determine whether or not the RED PLAY 1 LINE button 39, the PLAY 2 LINES button 40, the PLAY 5 LINES button 41, the PLAY 20 LINES button 42, or the BLACK PLAY 25 LINES button 43 has been operated. When the RED PLAY 1 LINE button 39 and the like have not been operated (NO in S23), processing returns to S21, and the aforementioned processing is repeated. On the other hand, when the RED PLAY 1 LINE button 39 and the like have been operated (YES in S23), processing returns to the main processing program even if demo effects are displayed, and proceeds to sample processing in S12.

In addition to the operation signal indicating that the RED PLAY 1 LINE button 39 and the like have been operated, other input signals may also be used as a tigger to commence lottery processing.

In S12 in FIG. 3, the lottery processing shown in FIG. 5 is executed based on the switch signals output from the aforementioned 1-LINE switch 62, the 2-LINES switch 63, the 5-LINES switch 64, the 20-LINES switch 65, and the 25-LINES switch 66. When winning a bonus game, the number of bonus game repetitions is determined, and selected by lottery from, for example, any of between 10 and 25 games.

The lottery processing program executed on the slot machine 1 is described based on FIG. 5. FIG. 5 is the lottery processing flowchart Lottery processing is executed in S12 of the main processing program shown in FIG. 3. As shown in FIG. 5, symbol determination processing (S31) is executed first in lottery processing. In base games, symbols stopped and displayed on the primary activated payline L1 are determined for each of the variable display units 21 through 25 in symbol determination processing. In practice, as described above, five random numbers corresponding to the variable display units 21 through 25 are sampled with the random number sampling circuit 56, and the stopped and displayed symbols are determined via the code numbers based on the primary lottery table in FIG. 17. Combination evaluation processing is executed in S32 when symbols stopped and displayed on the activated payline are determined, and processing returns to the main processing program. As described above, the winning combination and payout for same are determined in combination evaluation processing based on the table in FIG. 18 via the symbol code number determined in S31.

When a win occurs with lottery in the aforementioned S12 (YES in S13), processing proceeds to S14, the symbols are variably displayed on the variable display units 21 through 25, and stopped and displayed with the stopped and displayed symbols determined for the variable display units 21 through 25. In addition processing (S15), the payout for the combination of symbols stopped and displayed on the variable display units 21 through 25 is determined based on the table in FIG. 18, and coin equivalent to the determined payout is temporarily added to coin scheduled for payout.

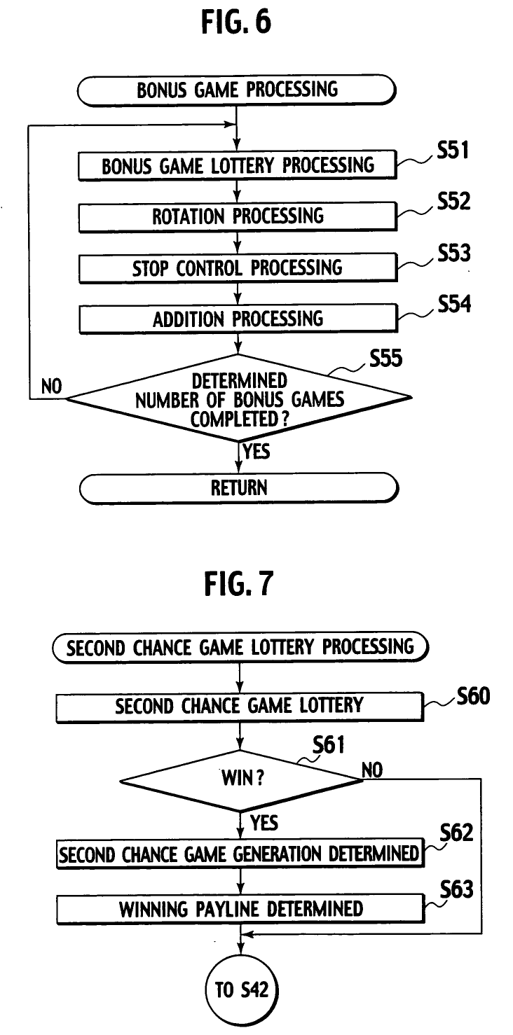

Next, processing proceeds to S16, and an evaluation is made to determine whether or nota win has occurred in a bonus game. If a win has occurred in a bonus game (YES in S16), bonus game processing is executed (S17). FIG. 6 is the bonus game processing flowchart Bonus game processing is executed when a win has occurred in a base game (YES in S16), however this processing requires that processing first proceed to S51 in FIG. 6 to execute lottery processing during the bonus game. Here, in bonus games, symbols stopped and displayed on the primary payline L1 and the secondary payline L2 are determined for each of the variable display units 21 through 25. In practice, as described above, five random numbers corresponding to the variable display units 21 through 25 are sampled with the random number sampling circuit 56, and the stopped and displayed symbols are determined via the code numbers based on the lottery table in FIG. 17. When symbols stopped and displayed in the paylines L1 and L2 are determined, the winning combination and payout for same are determined based on the table in FIG. 18 via these code numbers.

In the rotation processing in S52, each symbol is variably displayed automatically on the variable display units 21 through 25.

In the stop control processing in S53, variable display of each symbol on the variable display units 21 through 25 on which the symbols are scrolled is stopped automatically.

In the addition processing in S54, payout for stopped and displayed combinations of symbols is determined based on FIG. 18, and coin equivalent to the determined payout is temporarily added to coin scheduled for payout.

Next, processing proceeds to S55, and an evaluation is made to determine whether or not the number of times the bonus game is executed has reached the number determined in S12. If the number of times the bonus game is executed has not reached the number determined in S12 (NO in S55), processing returns to S51 and the aforementioned processing is repeated. On the other hand, if the number of times which the bonus game is executed has reached the number determined in S12 (YES in S55), the bonus game program is completed.

Even in S51, when a win has occurred in a bonus game, the number of repeats of the bonus game is newly determined, and this determined number of repeats is added to the ‘number of times determined in S12’ in the evaluation in S55. Thus, with a win in a bonus game during a bonus game, the player can move again to a bonus game. In practice, for example, when first moving to twenty bonus games, with wins in seventeen bonus games in the twelfth bonus game, twenty-five bonus games (20−12+17) are played.

Furthermore, when credit is finally acquired in a bonus game, a double-down game in which the relevant credit is bet is played following completion of the relevant bonus game, however a description of this point is omitted.

In the present embodiment, even when no win has occurred in S12 in FIG. 3, an evaluation is made to determine whether or not a second chance game has been generated when a plurality of prerequisite lines has been established. A prerequisite line is an activated payline in which the prerequisite state is established.

Any desirable conditions can be set for establishment of the prerequisite state. In the present embodiment, conditions for the establishment of the prerequisite state are four of the same symbols arrayed in the activated payline, and the remaining symbol is dissimilar, in a five-reel video slot game. However, conditions for establishment of the prerequisite state are not limited to the aforementioned conditions, and three of the same symbols can also be set, and three or more can be combined in a prescribed pattern. For example, a state in which a specific stop and display region (for example, the left or right end) in an activated payline is dissimilar may also be a condition for establishment of the prerequisite state. Furthermore, in the case of a three-reel video slot game, a state wherein the same symbol is at the left and right ends of the activated payline and the symbol at the center differs, can be the prerequisite state. In the prerequisite state, one symbol is short for a predetermined winning combination. The prerequisite state does not have to include same patterns in one activated payline.

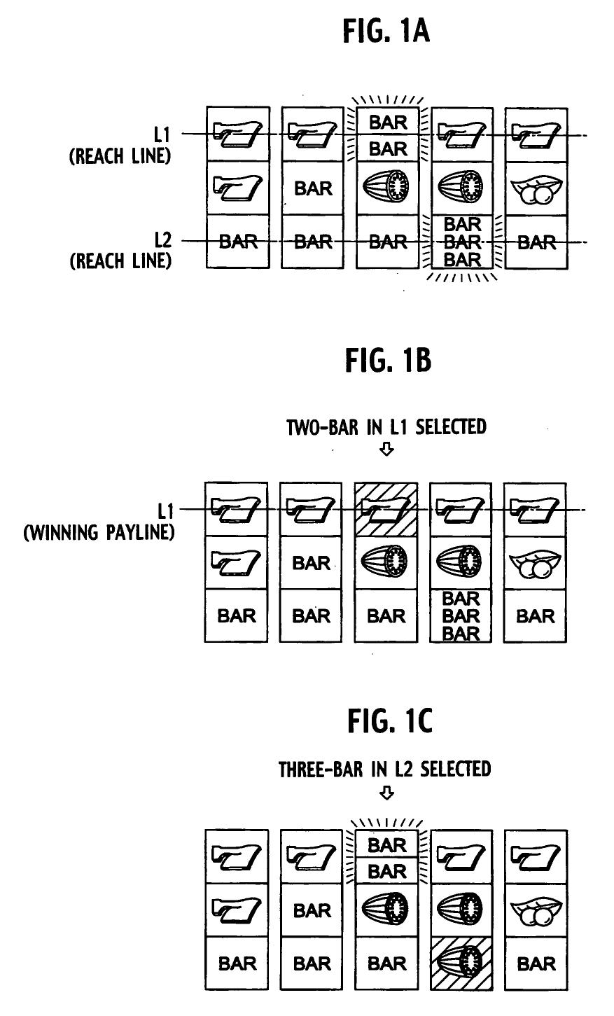

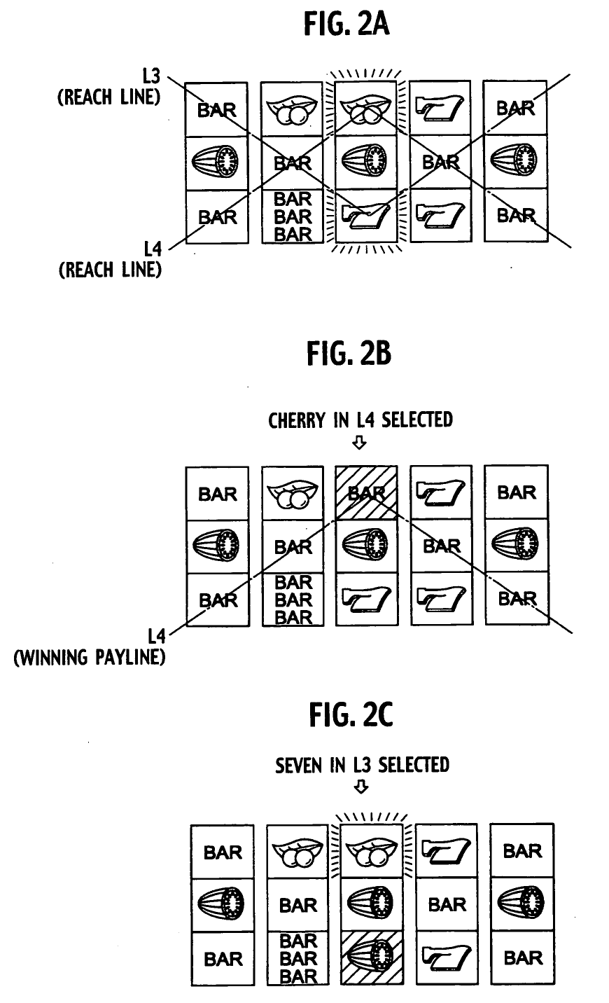

For example, FIG. 1A shows the state wherein the prerequisite state is established simultaneously for the two activated paylines L1 and L2, and two prerequisite lines have been generated. Furthermore, FIG. 2A shows the state wherein the prerequisite state is established simultaneously for the two activated paylines L3 and L4, and two prerequisite lines have been generated.

[Second Chance Game Lottery Processing]

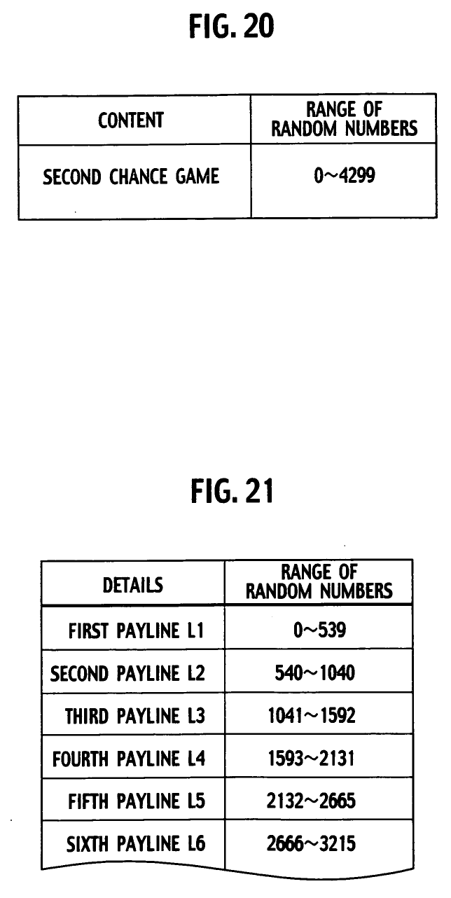

In the present embodiment, when a plurality of prerequisite lines are generated as shown in FIG. 1A and FIG. 2A, second chance game lottery processing is executed to provide an opportunity for re-lottery of some of the symbols not conformed to other symbols in the prerequisite line (S41 in FIG. 3). FIG. 7 is flowchart for the program executing second chance game lottery processing. In FIG. 7, second chance game lottery is executed first (S60). FIG. 20 is an explanatory diagram of a lottery table for lotter about whether or not to generate a second chance game. In second chance game lottery, one random number is sampled via the random number sampling circuit 56. A win occurs if the sampled random number is within the random number range ‘0’ to ‘4299’ shown in FIG. 20. For the number of population of the random number, arbitrary numbers more than 4299 can be set, for example 65536. The desired winning probability can be set by adjusting the random number range shown in FIG. 20. When a win occurs in a second chance game (S61), a flag indicating generation of a second chance game is set (S62), and the winning payline in the second chance game is determined (S63). For example, lottery is executed for each payline L1 through L25 using the lottery table shown in FIG. 21. Each random number is sampled via the random number sampling circuit 56 for each payline L1 through L25, and one or more wining paylines determined. The winning probability for each payline L1 through L25 is set to the desired winning probability by adjusting the random number range of the lottery table. Furthermore, as a further example, when a win occurs by executing lottery using the lottery table shown in FIG. 20, all prerequisite lines become winning lines, however when a win does not occur, none of prerequisite lines becomes the winning line. The case of a win is the case of the generated random number being between 0 and 4299 as shown in FIG. 20.

[Second Chance Game Evaluation Processing]

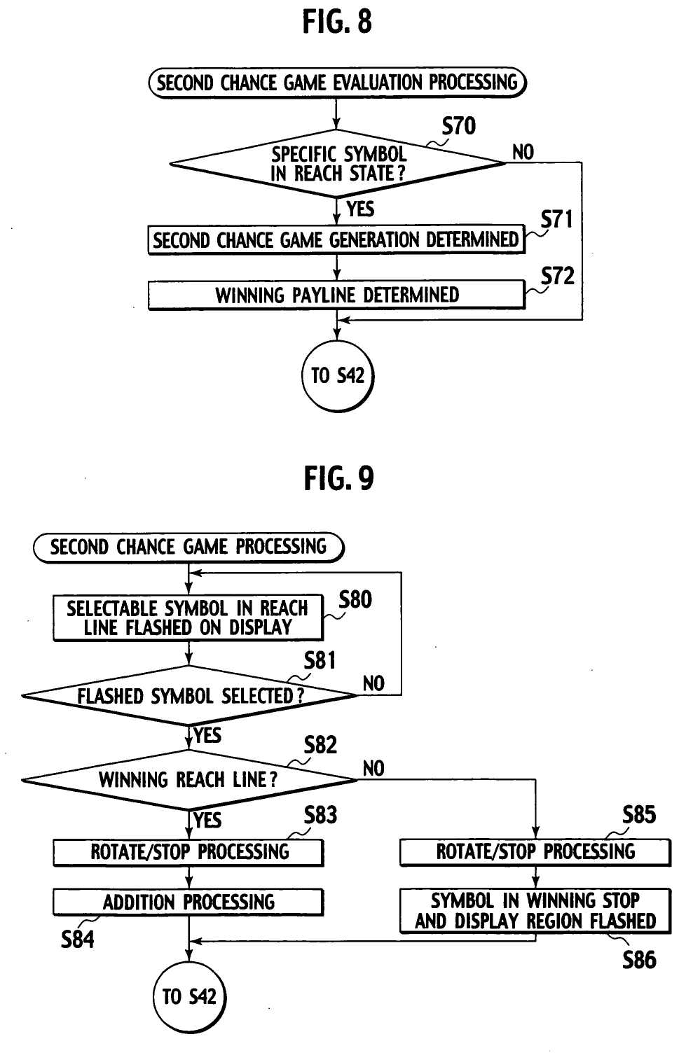

In the flowchart shown in FIG. 7, a second chance game is generated in the form of a mystery bonus, however if a prerequisite line is generated with a specific symbol (for example, ‘SEVEN’) as shown in FIG. 8, a second chance game may be generated without executing lottery. In this case, as shown in FIG. 8, an evaluation is made (S70) to determine whether or not the prerequisite line has been established with a specific symbol (for example, ‘SEVEN’), and if the prerequisite line has been established with a specific symbol (for example, ‘SEVEN’), a flag indicating generation of a second chance game is set (S71) without executing lottery and the winning payline is then determined from prerequisite lines (S72), or, a second chance game may be generated when prerequisite lines L3 and L4 as shown in FIG. 2A are the same symbol (‘one-BAR’) in the evaluation in S70.

In S42 in FIG. 3, stop control is executed to stop a specific symbol in each activated payline based on the lottery result in S12. As a result, a specific symbol in the prerequisite state is stopped and displayed in a plurality of activated paylines to bring about the prerequisite state. The base game is conventionally completed at this point, however in the present embodiment, the player can move to a second chance game if generation of a second chance game has been determined in S41.

That is to say, processing proceeds from S43 to S44, and second chance game processing is executed, when the second chance game generation flag is set in the processing in S62 in FIG. 7 or S71 in FIG. 8. FIG. 9 is the flowchart for the program executing second chance game processing. Firstly, of the symbols stopped and displayed in the variable display units 21 through 25, the selectable symbol in the prerequisite line is flashed (S80). The player is informed of having won in the second chance game by the flashing of the selectable symbol in the prerequisite line. In the example shown in FIG. 1A, the prerequisite line is comprised of the ‘SEVEN’ symbols in the activated payline L1, and the ‘two-BAR’ symbol in the center flashes as the selectable symbol. Furthermore, the prerequisite line is comprised of the ‘one-BAR’ symbols in the activated payline L2, and the ‘three-BAR’ symbol second from right flashes as the selectable symbol. The player selects either the selectable symbol in the activated payline L1 (‘two-BAR’ symbol), or the selectable symbol in the activated payline L2 (‘three-BAR’ symbol). In the present embodiment, symbols are selected by direct touch, however symbols may also be selected using buttons on a control panel.

The touch-panel 121 can discriminate, via the touch-panel driving circuit 122, where the stop and display region on each variable display unit 21 through 25 has been touched based on coordinate information for the part touched by the player (S81). An evaluation is then made (S82) to determine whether or not the prerequisite line belonging to the selectable symbols selected by the player matches the winning payline determined in S63 in FIG. 7 or S72 in FIG. 8. When a selectable symbol in the winning payline is selected, display control is executed (S83) to start scrolling the selected symbol and stop scrolling so that the stopped symbol is same as the other symbols forming the prerequisite state. In the examples shown in FIGS. 1A and 1B, the prerequisite line L1 is a winning payline, and when the player has selected the selectable symbol in the prerequisite line L1 (‘two-BAR’ symbol), the primary stop and display region 231 of the variable display unit 23 is variably displayed, and a ‘SEVEN’ symbol the same as the other symbols (‘SEVEN’ symbols forming the prerequisite state) are stopped and displayed in the primary stop and display region 231. As a result, ‘SEVEN’ symbols are arrayed in the activated payline L1 in the second chance game. In the examples in FIGS. 2A and 2B, the prerequisite line L4 is a winning payline, and when the player has selected the selectable symbol in the prerequisite line L4 (‘CHERRY’ symbol), the symbol in the primary stop and display region 231 of the variable display unit 23 is variably displayed, and a ‘one-BAR’ symbol the same as the other symbols (‘one-BAR’ symbols forming the prerequisite state) are stopped and displayed in the primary stop and display region 231. As a result, ‘one-BAR’ symbols are arrayed in the activated payline L4 in the second chance game.

In the addition processing in S84, a credit and the like equivalent to the payout determined in accordance with the combination of symbols stopped and displayed on the variable display units 21 through 25 is paid out. The payout is determined based on the table in FIG. 18.

On the other hand, when the player selects a selectable symbol in a prerequisite line other than the winning line, symbols stopped and displayed after variable display become symbols other than symbols forming the prerequisite state in the relevant prerequisite line (S85). In the examples shown in FIGS. 1A and 1C, the player selects the selectable symbol in the non-winning prerequisite line L2 (‘three-BAR’ symbol in the example in FIG. 1A). In this case, a symbol other than the ‘one-BAR’ symbol (‘MELON’ in the example in FIG. 1C) is stopped and displayed in the tertiary stop and display region 243 (S85) after the symbols in the tertiary stop and display region 243 of the variable display unit 24 are variably displayed. As a result, since ‘one-BAR’ symbols were not arrayed in the activated payline L2 even in second chance games, no payouts are obtained even for second chance games. Symbols to be selected in the winning payline L1 (‘two-BAR’ symbol in the example in FIG. 1C not selected this time) in S63 or S72 are then flashed (S86) and display control executed to inform the player of the winning symbol. Furthermore, in the examples shown in FIGS. 2A and 2C, the player selects the selectable symbol in the non-winning prerequisite line L3 (‘SEVEN’ symbol in the example in FIG. 2A). In this case, a symbol other than the ‘one-BAR’ symbol (‘MELON’ symbol in the example in FIG. 2C) is stopped and displayed in the tertiary stop and display region 233 (S85) after the symbols in the tertiary stop and display region 233 of the variable display unit 23 are variably displayed. Symbols to be selected in the winning payline L4 (‘CHERRY’ symbol in the example in FIG. 2C not selected this time) in S63 or S72 are then flashed (S86) and display control is executed to inform the player of the winning symbol. As a result, since ‘one-BAR’ symbols were not arrayed in the activated payline L3 even in second chance games, no payouts are obtained even for second chance games.

In S16 in FIG. 3, an evaluation is made to determine whether or not a win has occurred in a base game. In addition to the bonus game won in the lottery processing in S12, the bonus game won in the second chance game in S44 is included in the bonus game executed in S17. Coin for the number of payouts added to coin scheduled for payout in each of addition processing (S15) in base game processing, addition processing (S84 in FIG. 9) in second chance games, and addition processing (S54 in FIG. 6) in bonus game processing, is paid out in one lump sum, or payout processing is executed to newly add credit for the number of payouts held by the player (S18). After payout processing is executed, the CPU 50 returns processing to game receive processing (S11) ready to commence the next game.

As described above, according to the present embodiment, even when a win has not occurred in a base game, when a plurality of prerequisite lines are generated, an opportunity is provided for re-lottery of part of the variable display units 21 through 25 based on prescribed conditions (for example, a win with re-lottery, or a prerequisite line comprised of specific symbols is generated). Thus, since the probability of a win in a dissimilar line appears, the expectations of the player are increased, and a desire to continue the game develops. Furthermore, when a plurality of prerequisite lines are generated, since the player is made to select the selectable symbol in the desired prerequisite line, the player can be provided with an impression of actively playing the game.

When a plurality of prerequisite lines are generated, an opportunity for re-lottery of some of the variable display units 21 through 25 may be provided unconditionally.

The aforementioned description applies to an example of a five-reel format video slot game comprised of the five variable display units 21 through 25, however this description may similarly also apply to a three-reel format video slot game.

What is claimed is:

1. A gaming machine having a plurality of columns of variable display units wherein symbols in the variable display units are variably displayed and stopped, and a payout is made when the symbols are stopped in a prescribed combination in an activated payline, comprising:
a providing unit configured to provide opportunity for a re-lottery of some of the symbols in a prerequisite line when a plurality of the activated paylines are in a prerequisite state, as a result of a first lottery;
a detector configured to detect some of the symbols in the variable display unit selected in accordance with instructions of the player when opportunity for re-lottery is provided with the providing unit; and
a display controller configured to stop and display based on results of the re-lottery after some of the symbols detected with the detector have been variably displayed again.

2. The gaming machine according to claim 1, wherein the providing unit executes a second lottery when a plurality of activated paylines are in the prerequisite state, and provides opportunity for the re-lottery under a condition that a result of the second lottery is a win.

3. The gaming machine according to claim 1, wherein the providing unit provides opportunity for the re-lottery under a condition that a preset specific symbols is included in the prerequisite lines.

4. The gaming machine according to claim 1, wherein the display controller displays in a special manner a winning symbol included in the prerequisite line when a result of the re-lottery is a loss.
